(19) United States
(12) Patent Application Publication
(10) Pub. No.: US 2024/0402792 A1
(43) Pub. Date: Dec. 5, 2024

(54) MULTIMODE CURSOR MOVEMENT

(71) Applicant: Apple Inc., Cupertino, CA (US)

(72) Inventors: Jack H. Lawrence, San Francisco, CA (US); Mark A. Ebbole, San Francisco, CA (US); Evgenii Krivoruchko, San Francisco, CA (US)

(21) Appl. No.: 18/666,132

(22) Filed: May 16, 2024

Related U.S. Application Data
(60) Provisional application No. 63/469,965, filed on May 31, 2023.

(51) Int. Cl. G06F 3/01; G06F 3/0481; G06T 19/00

(52) U.S. Cl. CPC G06F 3/011; G06F 3/017; G06F 3/0481; G06T 19/006

(57) ABSTRACT

Various implementations disclosed herein include devices, systems, and methods that enable multi-mode interactions with elements in a three-dimensional (3D) environment based on cursor movement associated with tracking user hand motion. For example, a process may include presenting an extended reality (XR) environment comprising a virtual element and a cursor. The process may further include obtaining hand data corresponding to 3D movement of a hand in a 3D environment. The process may further include operating in first mode where the 3D motion of the hand is converted to two-dimensional (2D) motion and detecting a 3D user input criteria. In response to the 3D user input criteria a mode of operation is modified to a second mode where the 3D motion of the hand is maintained without conversion to the 2D motion.

### CROSS-REFERENCE TO RELATED APPLICATIONS

This application claims the benefit of U.S. Provisional Application Ser. No. 63/469,965 filed May 31, 2023, which is incorporated herein in its entirety.

### TECHNICAL FIELD

The present disclosure generally relates to systems, methods, and devices that enable interactions with elements in three-dimensional (3D) environments based on hand tracking.

### BACKGROUND

Extended reality (XR) systems provide content within 3D environments with which users may interact via various input mechanisms. Such systems may not provide adequate interaction functionalities, for example, with respect to using input to provide both interactions in the 3D space of the environment (e.g., moving objects around in 3D) and interactions on the surfaces of objects within the 3D space (e.g., controlling the selection and manipulation of objects displayed on a 2D user interface within the 3D space).

### SUMMARY

Various implementations disclosed herein include devices, systems, and methods that enable interactions with virtual elements within a (3D) space of an extended reality (XR) environment. The interactions may be enabled based on a cursor (visible or non-visible) being moved with respect to user hand motion tracking. Some implementations enable usage of two modes, e.g., two hand cursor modes. A first mode allows a user's 3D hand motion to move a hand cursor (and/or a virtual cursor) on a two-dimensional (2D) plane (e.g., the surface of a UI or other object) in response to converting 3D hand cursor motion to 2D hand cursor motion. For example, the hand cursor (and/or a virtual cursor) may be moved along a flat surface of a 2D user interface being displayed within a 3D space. A second mode allows a user's 3D hand motion to move a hand cursor within a 3D space without converting 3D cursor motion to 2D cursor motion. For example, a hand cursor and/or an associated object (e.g., an entire user interface) may be moved within a 3D space. In some implementations, the hand cursor may be linked with a virtual element (such as a user interface of the 3D space) such that the virtual element moves with respect to six degrees of freedom (6DOF) in combination with the cursor. Movement with respect to 6DOF allow the hand cursor and virtual element to move in a forward direction, a backward direction, a left direction, a right direction, an upward direction, a down direction, a twisting direction/motion, a tilting direction/motion, etc. based on a 3D movement of the hand.

In some implementations, the first mode may be automatically enabled until the second mode is triggered (or vice versa). For example, the second mode may be triggered in response to a user positioning a hand cursor on a specified object type (e.g., an object that may be moved within a 3D space, a user interface (UI) location control icon allowing for implementation of an object (e.g., UI) drag and drop operation, a drag operation, etc.) and providing user selection input (e.g., a user performing a finger pinch operation). In some implementations, the first mode may be reactivated when a user releases the selection input (e.g., the user terminates the finger pinch operation). In some implementations, the first mode may apply unless the second mode is triggered based on any type of pinch and hold (or any hand type of) gesture moving in a third, z-dimension with respect to an x-y dimension of the 2D plane.

In some implementations, the first and second modes may be associated with an application configured to enable Z motion of a hand to dynamically adjust a size of a virtual structure. Likewise, the first and second modes may be triggered in response to movement of the hand (e.g., a rotating the hand or translating the hand in the Z-dimension) to modify an attribute of the application.

In some implementations, interactions with virtual elements within a (3D) space of an extended reality (XR) environment may be enabled based on a cursor being moved with respect to input from a virtual reality (VR) controller.

In some implementations, an electronic device has a processor (e.g., one or more processors) that executes instructions stored in a non-transitory computer-readable medium to perform a method. The method performs one or more steps or processes. In some implementations, an XR environment comprising a virtual element and a cursor is presented. In some implementations, hand data corresponding to a 3D movement of a hand in a 3D environment is obtained. In some implementations, a first mode is operated such that the 3D motion of the hand is converted to 2D motion. In some implementations, 3D user input criteria is detected and in response, a mode of operation is modified to a second mode where the 3D motion of the hand is maintained without conversion to the 2D motion.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2I illustrate views of an XR environment in which multimode hand cursor movements are recognized as input, in accordance with some implementations.

FIG. 3 is a flowchart illustrating an exemplary method that enables interactions with elements in three-dimensional (3D) environment with respect to multimode hand cursor movement based on user hand motion tracking, in accordance with some implementations.

FIG. 4 is a flowchart illustrating an alternative exemplary method that enables interactions with elements in three-dimensional (3D) environment with respect to multimode hand cursor movement based on user hand motion tracking, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

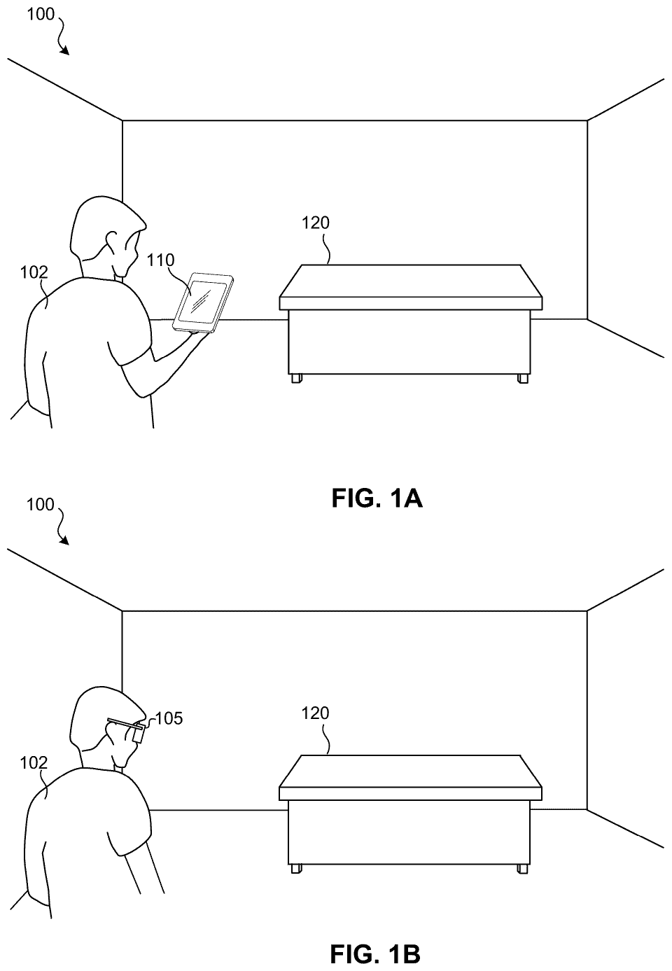

FIGS. 1A-B illustrate exemplary electronic devices 105 and 110 operating in a physical environment 100. In the example of FIGS. 1A-B, the physical environment 100 is a room that includes a desk 121. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an HMD (e.g., device 105) is configured to present an extended reality (XR) environment to a user. The XR environment may be a virtual reality (VR) environment or a mixed reality (MR) environment. The XR environment may include a virtual element/structure (e.g., a flat user interface (UI) positioned a specified distance in front of the user and presented via the HMD) and a cursor (e.g., a hand cursor, a virtual cursor, etc.). The HMD may be further configured to obtain data corresponding to three-dimensional (3D) movement of a hand (of a user) within a 3D environment. The data may be obtained via sensors including, inter alia, an outward facing image, depth sensor etc. comprised by the HMD. The sensors may be configured to capture images of a hand of the user and use the images to determine a 3D position of the hand and/or a configuration of the hand (e.g., a pose of a skeletal representation of the hand).

In some implementations, the HMD (or any intermediary device) may be configured to determine whether to provide a cursor-based interaction (e.g., with a virtual element such as a UI) using a first mode or a second mode in response to determining whether a specified user input criterion is satisfied. A specified user input criterion may be a specified type of UI element being currently selected. For example, a specified user input criterion may be a user currently performing a finger pinch operation (e.g., thumb to index finger, thumb to pointer finger, thumb to long finger, thumb to ring finger, thumb to pinky finger, thumb to any combination of fingers, etc.) while a cursor is currently located on a UI location control icon. Alternatively, a specified user input criteria may be a type of hand gesture (a pinch and hold gesture) moving in a third, z-dimension with respect to an x-y dimension of 2D plane presented within the XR environment via the HMD.

In some implementations, a first mode may enable a user's detected 3D hand motion to move a hand cursor and/or a virtual cursor on an object's surface (e.g., on a 2D plane) presented within the XR environment in response to converting 3D hand cursor motion to 2D hand cursor motion. For example, the hand cursor may be moved on or over a flat surface of a 2D user interface displayed within 3D space of the XR environment.

In some implementations, a second mode enables the user's 3D hand motion to move the hand cursor within 3D space without converting 3D hand cursor motion to 2D hand cursor motion (e.g., moving the hand cursor and an associated object such as an entire UI within 3D space). The first mode may apply unless the second mode is triggered (e.g., based on a user positioning the hand cursor on a particular object type (e.g., a “3D drag and drop” or drag type object and/or UI 3D location control icon) and providing selection input (e.g., holding a pinch gesture)). The first mode may be reactivated when the user releases the selection input (e.g., stops pinching). Alternatively, the first mode may apply unless the second mode is triggered based on any type of pinch and hold or any hand type of gesture moving in a third, z-dimension with respect to an x-y dimension of the 2D plane.

In some implementations, the aforementioned first and second modes may be triggered in response to an application (e.g., a drawing application) configured to enable Z motion of a hand to dynamically adjust a size of a virtual drawing structure (e.g., a paintbrush on a canvas). Likewise, the aforementioned first and second modes may be triggered in response to movement of the hand (e.g., a rotating the hand or translating the hand in the Z-dimension) to modify an attribute of the application (e.g., modify color of paint in the drawing application).

In some implementations, the aforementioned interactions with virtual elements and associated cursor modes may be enabled based on a cursor being moved with respect to input from a virtual reality (VR) controller instead of a hand cursor.

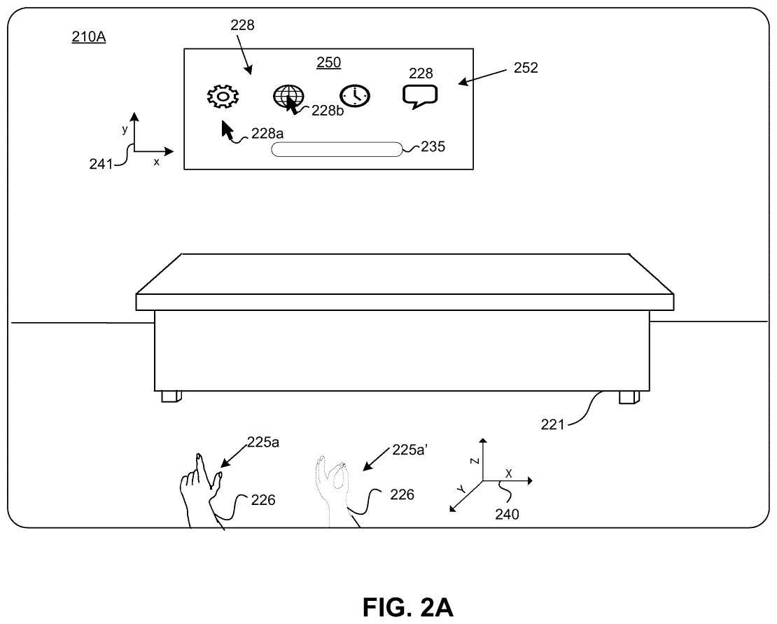

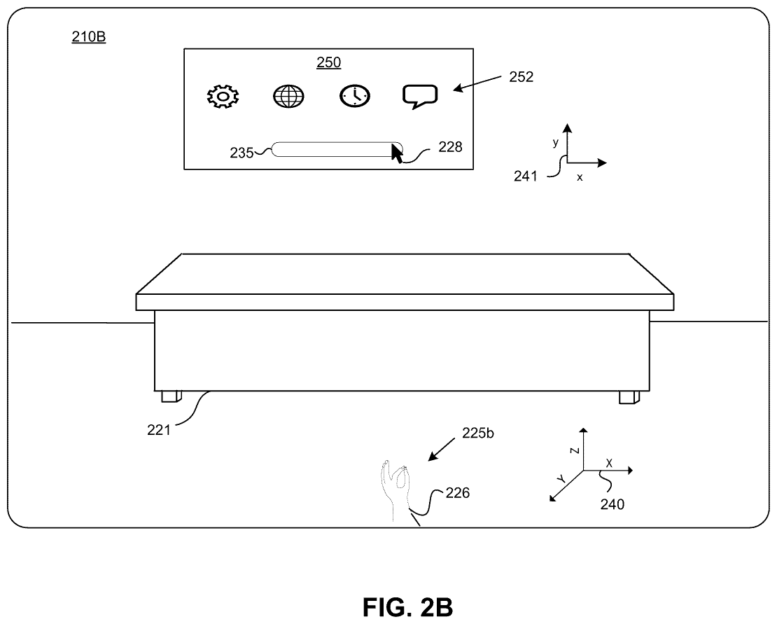

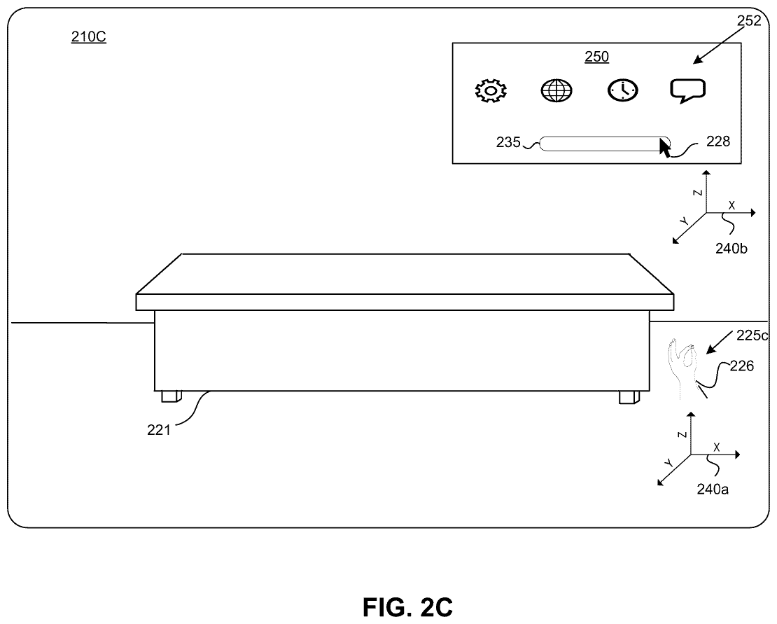

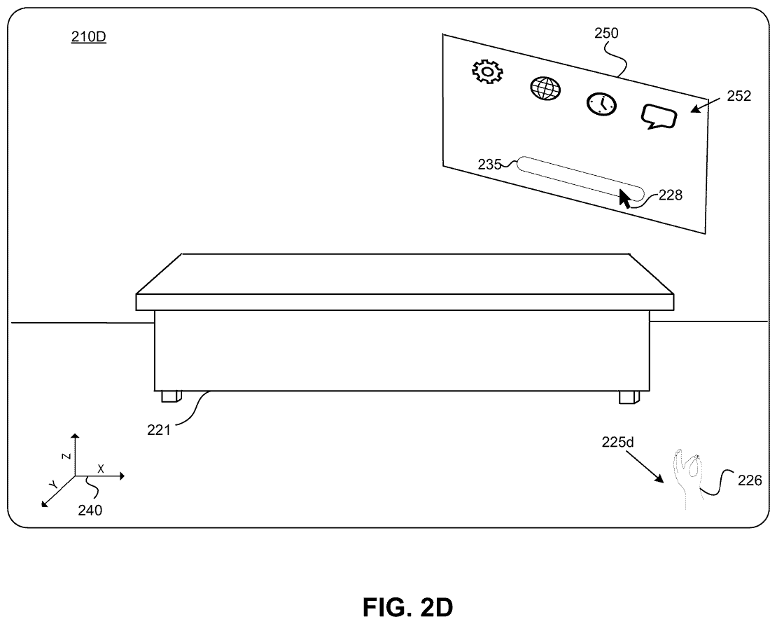

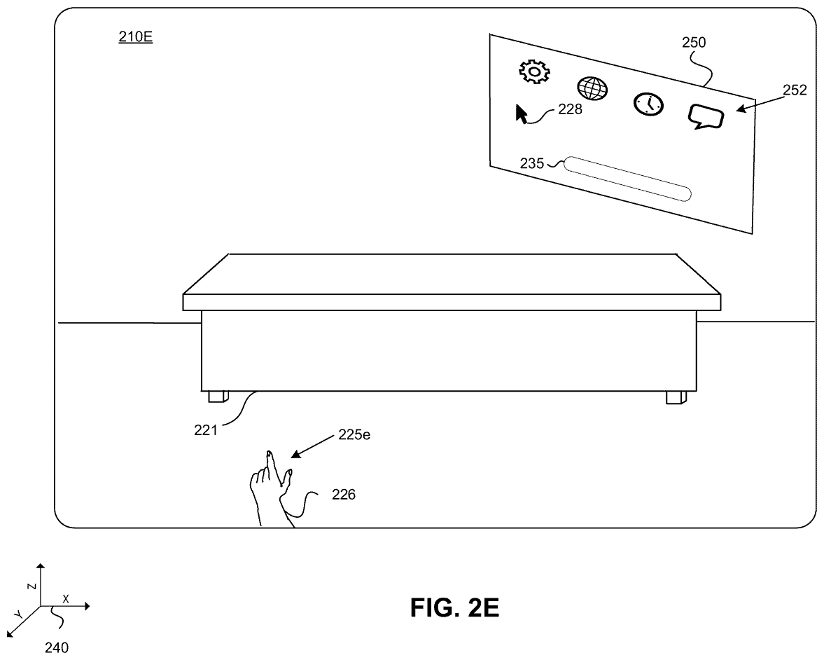

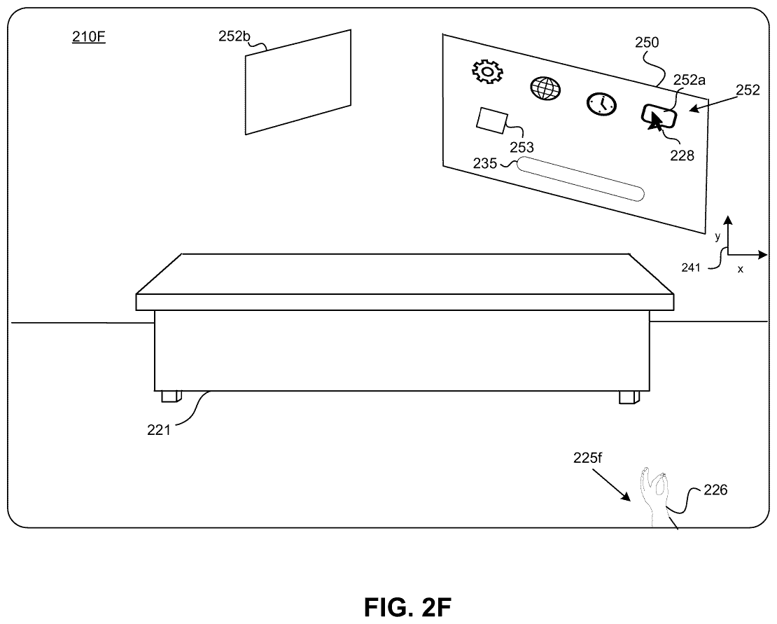

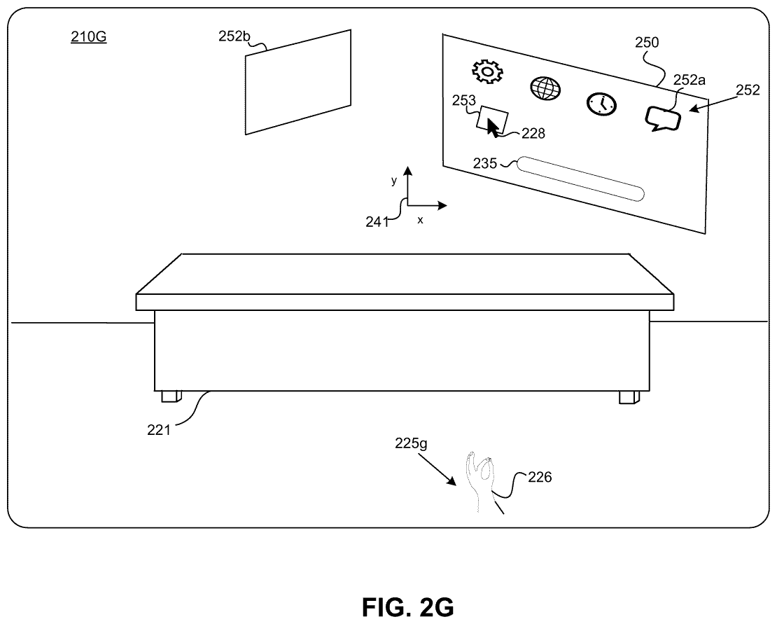

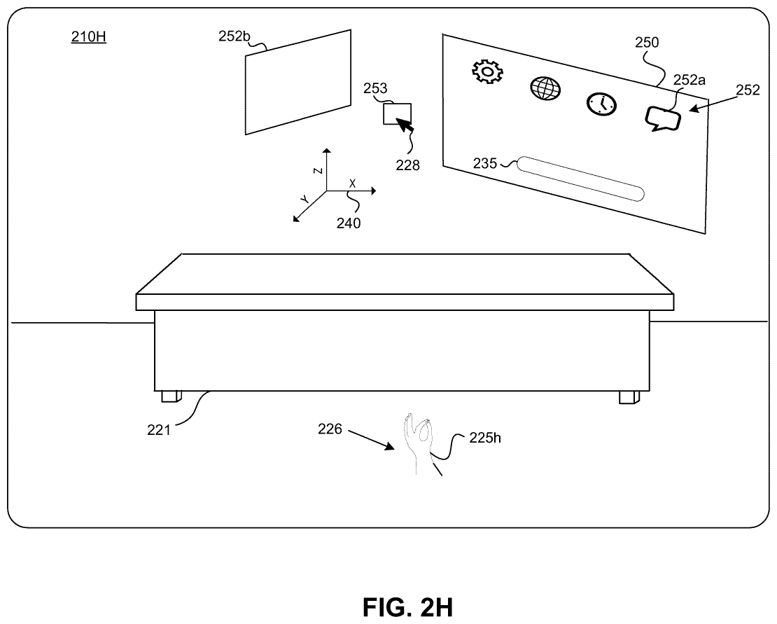

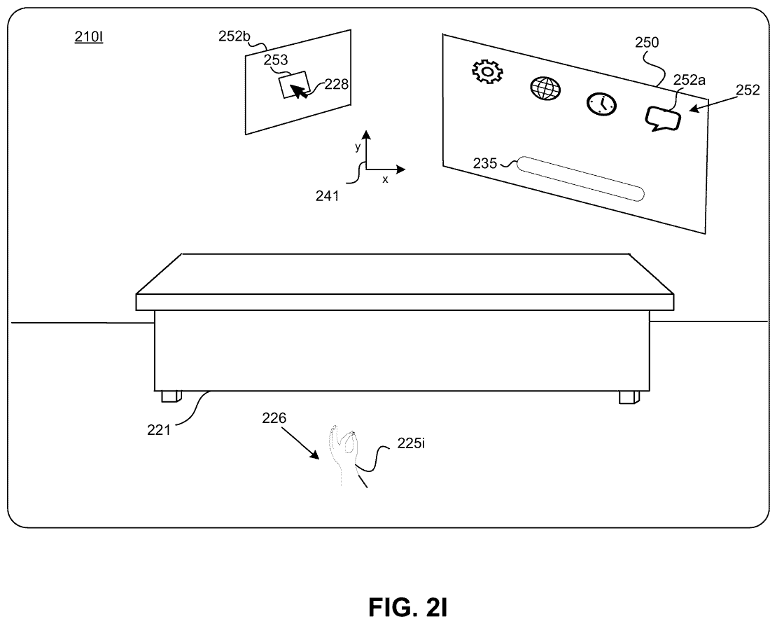

FIGS. 2A-2I illustrate views 210A-210I of an XR environment, provided by the device 105 and/or 110 of FIG. 1. The views 210A-210I include depictions 226 of a hand of the user performing various hand motion-based user input (e.g., gesture(s)). Each of FIGS. 2A-2I includes an exemplary user interface 250 and a depiction 221 of desk 121. Depiction 221 of desk 121 and depictions of other aspects of physical environment 100 may be viewed as pass-through video or may be a direct view of the physical object through a transparent or translucent display. User interface 250 may be any type of virtual element positioned at a 3D position within the XR environment and may be capable of being moved to another 3D position and/or reoriented within the XR environment. User interface 250 may be approximately two-dimensional/flat or may be a 3D object having a surface (e.g., flat, mostly flat, curved, etc.) upon which 2D interactions are possible. Providing views 210A-210I may involve determining 3D attributes of the physical environment 100 (e.g., of FIG. 1) and positioning virtual content, e.g., user interface 250, in a 3D coordinate system corresponding to that physical environment 100.

Additionally, FIGS. 2A-2I include various combinations of representations of hand movement gestures 225a-225i (e.g., an index finger pointing as illustrated in FIGS. 2A and 2E, fingers coming together and touching forming a pinch and hold gesture as illustrated in FIGS. 2B-2D, 2F-2I, etc.) of a hand (comprising fingers) 226 of user 102 of FIG. 1.

In the examples of FIGS. 2A-2I, the user interface 250 includes various user interface (visual) elements 252 (e.g., applications or icons representing software applications and/or user interfaces), an element 253 such as, inter alia, a photo (i.e., as illustrated in FIGS. 2F-2I), and an optional user interface 3D location control icon 235 allowing hand movements and gestures to select the user interface for 3D movement (e.g., in an X, Y, and Z degrees of motion 240) to differing locations within the XR environment as described, infra.

In the examples of FIGS. 2A-2I, an indicator 228 (e.g., a pointer, a cursor, etc.) may be provided to indicate a point of interaction with any of user interface elements 252, element 253 (e.g., a document or a photo), or user interface 250. For example, indicator 228 may indicate an interaction with user interface 3D location control icon 235 for allowing hand movement gestures 225a-225i to move the user interface 250 itself to differing 3D locations and orientations within the XR environment (e.g., performing a “3D drag and drop operation” with respect to moving user interface 250 to a differing location within the XR environment).

The following process represents an example (illustrated via views 210A-210I of FIGS. 2A-2I) associated with using a hand cursor mode to initiate a drag and drop or drag operation (of user interface 250) with respect to X, Y, and Z motion of hand 226 (represented by hand movement gestures 225a-225i) for a duration of the drag and drop or drag operation thereby allowing the user interface 250 to travel in a full 3D space (of the XR environment) during the drag and drop or drag operation. The process is initiated when a user enables a hand cursor mode. In response, 3D hand cursor motion is converted to 2D hand cursor motion. Subsequently, a user moves the cursor (e.g., indicator 228) over a draggable object such as user interface 250 and/or element 253 and performs a pinch gesture to select the draggable object located below the cursor. When the user begins a drag operation, the 2D hand cursor motion is converted to a full 3D hand cursor motion allowing full 3D movement (in accordance with full 3D (6DOF) hand motion) of the user interface 250 (i.e., providing corresponding 6DOF changes to position and orientation of the UI 250) within the XR environment. When the user releases the pinch gesture, the user interface 250 is dropped at a specified location in the XR environment and the 3D hand motion is converted back to 2D hand motion. During the drag and drop or drag operation, indicator 228 may not be visible to the user but may be made visible subsequent to the completion of the drag and drop operation.

In the examples of FIGS. 2A-2I, the user interface 250 is simplified for purposes of illustration and user interfaces in practice may include any degree of complexity, any number of differing applications and/or computer interaction-based items, and/or combinations of 2D and/or 3D content. The user interface 250 may be provided by operating systems and/or applications (user interface elements) of various types including, but not limited to, messaging applications, web browser applications, content viewing applications, content creation and editing applications, photos, or any other applications that can display, present, or otherwise use visual and/or audio content.

Each of FIGS. 2A-2I illustrate a user hand motion (of hand 226 represented by hand movement gestures 225a-225i) at differing periods of time.

In FIG. 2A, at a first instant in time corresponding to view 210A, a hand cursor mode is enabled (via a first mode) and motion of a hand movement gesture 225a causes corresponding motion of indicator 228 (i.e., visible or non-visible). The motion of the hand movement gesture 225a is converted from 3D motion (e. g., X, Y, and Z degrees of motion 240) to 2D motion (X and Y degrees of motion 241) for planar movement with respect to X, Y motion (on a surface of a virtual object such as UI 250) without allowing Z motion (e.g., motion moving above or below the plane of the UI 250). As a result of the conversion, the 3D hand movement gesture 225a to 225a′ produces an associated motion of the indicator 228 in a direction on the 2D surface of the user interface 250 from positions 228a to 228b.

For example, FIG. 2A illustrates 2D motion (subsequent to 3D to 2D conversion) on user interface 250 such that hand movement gesture 225a causes an associated movement of indicator 228 (illustrated as 228a representing indicator 228 at a first moment in time) from a first position on UI 250 to a second position on UI 250 (i.e., indicator 228 is illustrated as 228b representing indicator 228 at a second moment in time located at a position over one of user interface elements 252). Subsequently, a selection of the user interface element 252 is enabled in response to the user providing a selection input (i.e., a pinch gesture made via hand movement gesture 225a′) while indicator 228 (illustrated as 228b representing indicator 228 at the second moment in time) is located over one of user interface elements 252 thereby launching an application associated with one of the user interface elements 252. Prior to movement of indicator 228 onto UI 250, hand cursor motion (i.e., motion of the hand with respect to motion of indicator 228) is converted from 3D motion (e. g., X, Y, and Z degrees of motion 240) to 2D (e.g., X and Y degrees of motion 241) motion thereby allowing planar movement (over UI 250 and subsequently over one of user interface elements 252) with respect to X, Y motion (on a surface of UI 250 and user interface elements 252) without allowing Z motion (e.g., motion moving above or below the plane of the UI 250). 2D motion allowing planar movement allows a user to control the movements of indicator 228 on the surface of the UI 250.

In FIG. 2B, during a period of time corresponding to view 210B, hand movement gesture 225b causes an associated movement of indicator 228 such that indicator 228 is located over user interface 3D location control icon 235 (within or associated with user interface 250). Hand movement gesture 225b may comprise any type of hand gesture including, inter alia, a pinch gesture, a movement of the hand in 3D space, etc. User interface 3D location control icon 235 can be a UI element capable of being used in another mode of a hand-based input, e.g., a 3D input mode. Such a mode may enable hand-based input (e.g., hand movement gesture 225b) to switch modes and select user interface 250 for moving to a differing 3D location within XR environment depicted in view 210a. Alternatively, indicator 228 may be positioned directly over another portion of user interface and other input recognized to enable the 3D input mode, e.g., for selection of user interface 250 for moving user interface 250 to a differing location within the XR environment.

In some implementations, a transition to another mode of hand-based input (e.g., a 3D mode) is initiated based on a selection operation on user interface 3D location control icon 235. The selection operation may be enabled via hand movement gesture 225b performing a pinch and hold operation. Alternatively, the selection operation may be enabled via hand movement gesture 225b performing any type of hand gesture (e.g., an open palm facing up, a fist, a thumb or any finger pointed up, a hand waving, etc.). Likewise, the selection operation may be enabled via a combination hand movement gesture 225b and/or an additional hand movement gesture performed by an additional hand. Likewise, the selection operation may be enabled via a combination hand movement gesture 225b and/or a gaze-based gesture (implemented via an eye tracking process). In response to the selection operation, the other mode of hand-based input (e.g., the 3D mode) is initiated and 3D motion of a hand movement gesture 225b moves indicator 228 and produces corresponding 3D motion of the indicator 228 and the entire user interface 250 in 3D, e.g., changing with respect to 6DOF based on 6DOF movements of the hand.

In FIG. 2C, at a third instant in time corresponding to view 210C, 3D movement of hand movement gesture 225c (e. g., with respect to X, Y, and Z degrees of motion 240) in combination with indicator 228 has moved user interface 250 in all three dimensions (e. g., with respect to X, Y, and Z degrees of motion 240) to a different location (with respect to a location of user interface in FIG. 2B) in the XR environment. The movement of hand movement gesture 225c (during a pinch and hold operation), indicator 228, and user interface 250 has been performed (i.e., via a 3D hand cursor mode) with respect to full 3D motion (within XR environment 210) in all directions such as X, Y, and Z.

Alternatively, movement of a hand movement gesture, indicator, and user interface may be performed in response to a twisting motion (made by a hand movement gesture) with respect to full 3D motion (within an XR environment) in all directions such as X, Y, and Z (e.g., 6DOF).

In FIG. 2D, at a fourth instant in time corresponding to view 210D, hand movement gesture 225d in combination with indicator 228 has moved user interface 250 to a differing location and orientation (with respect to a location of user interface in FIG. 2C) in the XR environment. The movement of hand movement gesture 225d (during a pinch operation), indicator 228, and user interface 250 has been performed (i.e., via a 3D hand cursor mode) in response to a twisting motion (made by hand movement gesture 225c) with respect to full 3D motion (within XR environment 210) in all directions such as X, Y, and Z (e.g., 6DOF). User interface 250 is illustrated as being tilted inward in a Z direction.

In FIG. 2E, at a fifth instant in time corresponding to view 210E, hand movement gesture 225e has disabled the selection operation by releasing the pinch operation, thereby transitioning the hand cursor (i.e., hand movement gesture 225b and/or indicator 228) back to the 2D input mode for interaction with user interface 250 (e.g., performed a drop operation). In response, 3D motion of a hand movement gesture 225e is converted to 2D motion for planar movement with respect to X, Y motion without allowing any type of Z motion. Subsequently, the hand movement gesture 225e in combination with indicator 228 is moved in a direction away from user interface 250 to optionally perform operations with respect to additional objects within XR environment.

In FIG. 2F, at a sixth instant in time corresponding to view 210F, hand movement gesture 225f (with respect to a 2D input mode (e.g., with respect to X and Y degrees of motion 241) for interaction with user interface 250) causes an associated movement of indicator 228 such that indicator 228 is located over a user interface (visual) element 252a (e.g., a messaging application) while hand movement gesture 225f performs a pinch and hold gesture. The pinch and hold gesture causes the user interface (visual) element 252a to open as an application UI 252b (e.g., a messaging application UI).

In FIG. 2G, at a seventh instant in time corresponding to view 210G, hand movement gesture 225g (with respect to a 2D input mode (e.g., with respect to X and Y degrees of motion 241) for interaction with user interface 250) causes an associated movement of indicator 228 such that indicator 228 is located over element 253 (e.g., a photo) while hand movement gesture 225g performs a pinch and hold gesture. The pinch and hold gesture causes the element 253 to be selected for a drag and drop operation.

In FIG. 2H, at a seventh instant in time corresponding to view 210h, hand movement gesture 225h (with respect to a 3D input mode (e.g., with respect to X, Y, and Z degrees of motion 240) for interaction within an XR environment provided within view 210H) causes an associated movement of indicator 228 (during a pinch and hold gesture) such that the element 253 has been moved (e.g., dragged) from user interface 250 to the XR environment provided within view 210H (i.e., towards application UI 252b (e.g., a messaging application UI).

In FIG. 2I, at an eighth instant in time corresponding to view 210I, hand movement gesture 225i (with respect to a 2D input mode (e.g., with respect to X and Y degrees of motion 241) for interaction with application UI 252b) causes an associated movement of indicator 228 such that the element 253 has been moved (e.g., dragged) from user interface 250 (in 2D) across the XR environment (in 3D) to application UI 252b (e.g., a messaging application UI). When the pinchand hold operation is terminated, the element 253 is dropped within application UI 252b so that the hand movement gesture 252i in combination with indicator 228 may be moved in a direction away from application UI 252b to optionally perform operations with respect to additional objects within the XR environment.

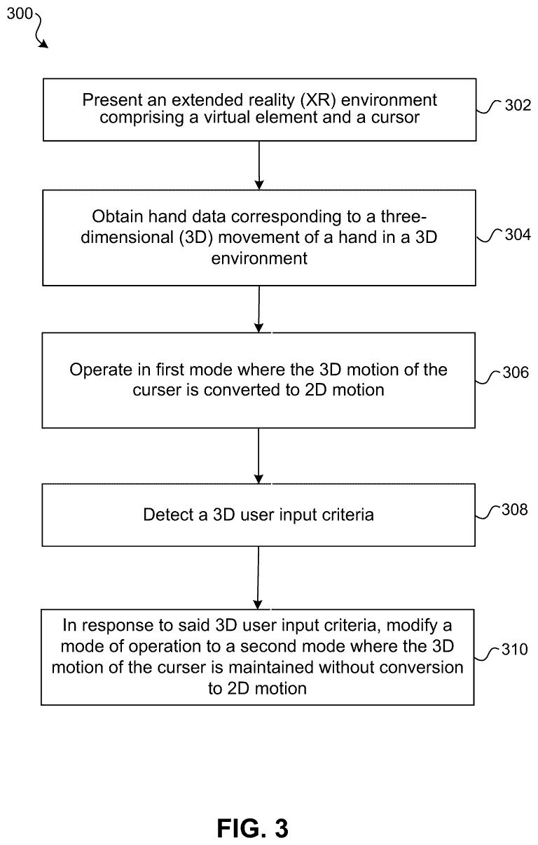

FIG. 3 is a flowchart representation of an exemplary method 300 that enables interactions with elements in three-dimensional (3D) environment with respect to multimode hand cursor movement based on user hand motion tracking. In some implementations, the method 300 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 300 is performed by processing logic, including hardware, firmware, software, or a combination thereof. In some implementations, the method 300 is performed by a processor executing code stored in a non-transitory computer-readable medium (e.g., a memory). Each of the blocks in the method 300 may be enabled and executed in any order.

At block 302, the method 300 presents (via an electronic device such as, inter alia, an HMD) an extended reality (XR) environment comprising a virtual element and a cursor. For example, the virtual element may be a flat user interface positioned a meter or two in front of a user.

At block 304, the method 300 obtains hand data corresponding to three-dimensional (3D) motion of a hand in a 3D environment. For example, an outward facing image and/or depth sensor on an HMD may capture images of a hand and determine a 3D position of the hand and/or a configuration of the hand (e.g., a pose of a skeletal representation of the hand).

At block 306, the method 300 operates the electronic device in first mode such that the 3D motion of the cursor is converted to 2D motion. For example, in the first mode, cursor movement of the cursor, is limited to 2D motion.

At block 308, the method 300 detects a 3D user input criteria. The 3D user input criteria may enable a particular type of UI element to be selected. In some implementations, the 3D user input criteria may determine that the cursor is on an object having an object type while a selection input is provided. (e.g., the cursor on the UI location control icon). In some implementations, the 3D user input criteria comprises performing a user gesture and moving the hand in a z-direction. For example, the user gesture may comprise a pinch gesture.

At block 310, the method 300 (in response to the 3D user input criteria) modifies a mode of operation to a second mode such that the 3D motion of the cursor is maintained without conversion to the 2D motion.

In some implementations, the second mode is provided while the user gesture is maintained. For example, the second mode may be provided while a pinch gesture continues.

In some implementations, both the cursor and the virtual object are moved in 3D space based on the 3D motion of the hand while the user gesture is maintained.

In some implementations, the first mode is provided based on determining that the user gesture has been discontinued.

In some implementations, 3D movement of the virtual element is enabled via the second mode.

In some implementations, the first mode enables the cursor to move on a surface of the virtual element and the second mode enables the virtual element to move within the XR environment while a position of the cursor on the surface of the virtual element is maintained.

In some implementations, the virtual object is moved based on the 3D motion of the hand while the user gesture is maintained.

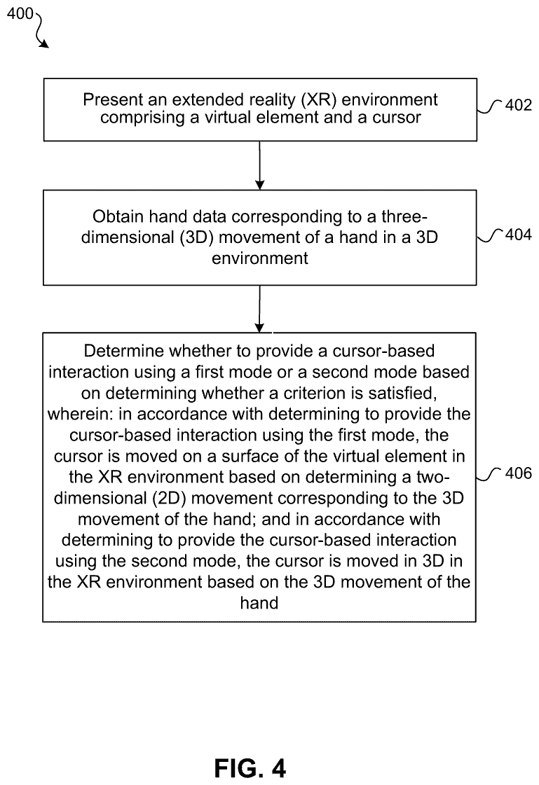

FIG. 4 is a flowchart representation of an exemplary method 400 that enables interactions with elements in three-dimensional (3D) environment with respect to multimode hand cursor movement based on user hand motion tracking, in accordance with some implementations. In some implementations, the method 400 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 presents (via an electronic device such as, inter alia, an HMD) an extended reality (XR) environment comprising a virtual element and a cursor. For example, the virtual element may be a flat user interface positioned a meter or two in front of a user.

At block 404, the method 400 obtains hand data corresponding to three-dimensional (3D) motion of a hand in a 3D environment. For example, an outward facing image and/or depth sensor on an HMD may capture images of a hand and determine a 3D position of the hand and/or a configuration of the hand (e.g., a pose of a skeletal representation of the hand).

At block 406, the method 400 determines whether to provide a cursor-based interaction using a first mode or a second mode based on determining whether a criterion is satisfied. For example, a criterion may include whether a particular type of UI element is currently selected such as e.g., a user is currently pinching while the cursor is on UI location control icon.

In some implementations, in accordance with determining to provide the cursor-based interaction using the first mode, the cursor is moved on a surface of the virtual element in the XR environment based on determining a two-dimensional (2D) movement corresponding to the 3D movement of the hand.

In some implementations, in accordance with determining to provide the cursor-based interaction using the second mode, the cursor is moved in 3D in the XR environment based on the 3D movement of the hand. For example, the cursor may be linked with the virtual element such that the virtual element moves in 6DOF with the cursor such that, inter alia, a UI moves forward, backward, left, right, up, down, twists, tilts, etc. based on the 3D movement of the hand.

In some implementations, based on said determining to provide the cursor-based interaction using the first mode, cursor movement is limited to 2D movement.

In some implementations, determining whether the criterion is satisfied comprises determining whether a particular type of UI element is currently selected.

In some implementations, determining whether a particular type of UI element is currently selected comprises determining whether the cursor is on an object having an object type while a selection input is provided.

In some implementations, the method 400 determines to provide the cursor-based interaction using the second mode in response to a user gesture (e.g., a pinch) selecting an object.

In some implementations, the method 400 determines to provide the cursor-based interaction using the second mode while the user gesture is maintained. (e.g., while the pinch continues).

In some implementations, both the cursor and the virtual object are moved based on the 3D movement of the hand while the user gesture is maintained.

In some implementations, it is determined to provide the cursor-based interaction using the first mode based on determining that the user gesture has been discontinued.

In some implementations, 3D movement of the virtual element is enabled based on determining to provide the cursor-based interaction using the second mode.

In some implementations, the first mode moves the cursor on a surface of the virtual element and the second mode moves the virtual element within the XR environment while a position of the cursor on the surface of the virtual element is maintained.

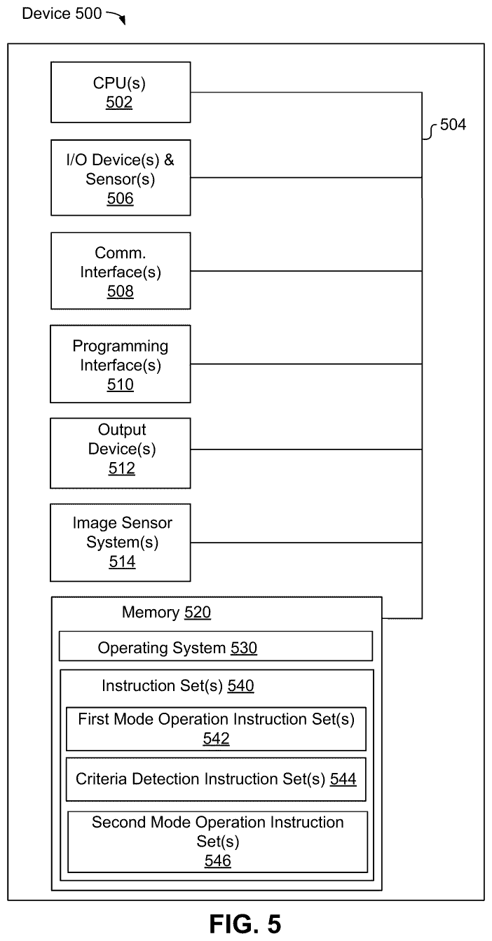

FIG. 5 is a block diagram of an example device 500. Device 500 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a first mode operation instruction set 542, a criteria detection instruction set 544, and a second instruction set 546. The instruction set(s) 540 may be embodied as a single software executable or multiple software executables.

The first mode operation instruction set 542 is configured with instructions executable by a processor to enable a first hand cursor mode for converting 3D motion of a hand and cursor to 2D motion.

The criteria detection instruction set 544 is configured with instructions executable by a processor to detect a 3D user input criteria such as a pinch gesture while moving a hand in a z-direction.

The second mode operation instruction set 546 is configured with instructions executable by a processor to modify (in response to the 3D user input criteria) a mode of operation to a second mode such that the 3D motion of the hand is maintained without conversion to the 2D motion.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Returning to FIG. 1, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and a display:
presenting an extended reality (XR) environment comprising a virtual element and a cursor;
obtaining hand data corresponding to a three-dimensional (3D) motion of a hand in a 3D environment;
operating in first mode where 3D motion of the cursor is converted to 2D motion;
detecting a 3D user input criteria; and
in response to said 3D user input criteria, modifying a mode of operation to a second mode where the 3D motion of the cursor is maintained without conversion to the 2D motion.

2. The method of claim 1, wherein, based on said operating in the first mode, cursor movement, of the cursor, is limited to 2D motion.

3. The method of claim 1, wherein the 3D user input criteria enables a particular type of UI element to be selected.

4. The method of claim 3, wherein the 3D user input criteria determines that the cursor is on an object having an object type while a selection input is provided.

5. The method of claim 1, wherein the 3D user input criteria comprises performing a user gesture and moving the hand in a z-direction.

6. The method of claim 5, wherein the method determines to provide the second mode while the user gesture is maintained.

7. The method of claim 5, wherein the user gesture comprises a pinch gesture.

8. The method of claim 5, further comprising moving both the cursor and the virtual object based on the 3D motion of the hand while the user gesture is maintained.

9. The method of claim 5 further comprising determining to provide the first mode based on determining that the user gesture has been discontinued.

10. The method of claim 1, further comprising enabling 3D movement of the virtual element using the second mode.

11. The method of claim 1, wherein:
the first mode moves the cursor on a surface of the virtual element; and
the second mode moves the virtual element within the XR environment while a position of the cursor on the surface of the virtual element is maintained.

12. The method of any of claim 1, further comprising moving the virtual object based on the 3D motion of the hand while the user gesture is maintained.

13. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
presenting an extended reality (XR) environment comprising a virtual element and a cursor;
obtaining hand data corresponding to a three-dimensional (3D) movement of a hand in a 3D environment; and
operating in first mode where the 3D motion of the cursor is converted to 2D motion;
detecting a 3D user input criteria; and
in response to said 3D user input criteria, modifying a mode of operation to a second mode where the 3D motion of the cursor is maintained without conversion to the 2D motion.

14. The electronic device of claim 13, wherein, based on said operating in the first mode, cursor movement, of the cursor, is limited to 2D motion.

15. The electronic device of claim 13, wherein the 3D user input criteria enables a particular type of UI element to be selected.

16. The electronic device of claim 15, wherein said 3D user input criteria determines that the cursor is on an object having an object type while a selection input is provided.

17. The electronic device of claim 13, wherein the 3D user input criteria comprises performing a user gesture and moving the hand in a z-direction.

18. The electronic device of claim 17, wherein the method determines to provide the second mode while the user gesture is maintained.

19. The electronic device of claim 17, wherein the user gesture comprises a pinch gesture.

20. A non-transitory computer-readable storage medium storing program instructions executable via one or more processors, of an electronic device, to perform operations comprising:
presenting an extended reality (XR) environment comprising a virtual element and a cursor;
obtaining hand data corresponding to a three-dimensional (3D) movement of a hand in a 3D environment; and
operating in first mode where the 3D motion of the cursor is converted to 2D motion;
detecting a 3D user input criteria; and
in response to said 3D user input criteria, modifying a mode of operation to a second mode where the 3D motion of the cursor is maintained without conversion to the 2D motion.
